(19) United States
(12) Patent Application Publication
(10) Pub. No.: US 2019/0232726 A1
(43) Pub. Date: Aug. 1, 2019

(54) PNEUMATIC VEHICLE TIRE

(71) Applicant: Continental Reifen Deutschland GmbH, Hannover (DE)

(72) Inventors: Andre LUTZ, Hannover (DE); Florian KRISTEN, Hannover (DE)

(21) Appl. No.: 16/313,093

(22) PCT Filed: Mar. 27, 2017
(86) PCT No.: PCT/EP2017/057160

§ 371 Date: Dec. 24, 2018

(30) Foreign Application Priority Data
Jun. 22, 2016 (DE) 10 2016 211 108.6

(51) Int. Cl. B60C 11/04

(52) U.S. Cl. CPC B60C 11/047; B60C 2011/0355

(57) ABSTRACT

Pneumatic vehicle tire having a tread profile with profile bands separated by circumferential channels, each delimited outward by an outer surface and toward the channel by a flank forming a channel wall. In a channel base, first and second rubber blocks are formed. The first blocks are attached in the flank of the first band and the second blocks are attached in the flank of the second band. The first and second blocks are arranged one behind the other in an alternating sequence. Each first block extends in the axial direction as far as a position in the axial extent region of two second blocks and ends with a spacing to the flank of the second band. Each second block extends the axial direction as far as a position in the axial extent region of two first blocks and ends with a spacing to the flank of the first band.

### CROSS REFERENCE TO RELATED APPLICATIONS

This application is the national stage of PCT/EP2017/057160, filed Mar. 27, 2017, designating the United States and claiming priority from German patent application no. 10 2016 211 108.6, filed Jun. 22, 2016, the entire contents of which are incorporated herein by reference.

### FIELD OF THE INVENTION

The invention relates to a pneumatic vehicle tire—in particular utility vehicle tire—having a tread profile with profile bands which are separated from one another by circumferential channels. The circumferential channels are each delimited inward in a radial direction R by a channel base and to both sides of the channel base by a channel wall, wherein the two profile bands separated by the circumferential channel are delimited outward in the radial direction R by a radially outer surface, which forms the road contact surface, and in an axial direction A toward the circumferential channel in each case by a flank, which extends in the radial direction R from the channel base to the radially outer surface and which forms a channel wall of the circumferential channel, wherein, in the channel base of at least one circumferential channel, there are formed first rubber blocks arranged one behind the other in the circumferential direction U and second rubber blocks arranged one behind the other in the circumferential direction U, wherein the first rubber blocks are attached in the flank of the first profile block band and the second rubber blocks are attached in the flank of the second profile block band,

### BACKGROUND OF THE INVENTION

From U.S. Pat. No. 8,225,832, it is known, in wide circumferential channels of a pneumatic vehicle tire, for two axially mutually spaced-apart rows of rubber blocks extending over the circumference of the tire to be formed in the channel base, wherein the rubber blocks of one row are attached to the flank of one circumferential rib that delimits the circumferential channel and in the channel base, and the rubber blocks of the other row are attached to the flank of the other circumferential rib that delimits the circumferential channel and in the channel base. The blocks of one row are spaced apart axially from the blocks of the other row to such an extent that, between the two rows, a circumferential channel extending rectilinearly in the circumferential direction remains fully formed even in the channel base. Within one row, the rubber blocks are arranged closely one behind the other in the circumferential direction, such that, in this way, the ingress of stones into the region of the channel base is impeded, and the expulsion is facilitated. In the case of very wide circumferential channels, the expulsion of stones can be made possible in this way. In the case of very wide circumferential channels, the rectilinear channel formed between the rubber block rows can permit the admission and throughflow of water. In the case of very wide channels, such a configuration can thus possibly be implemented. The circumferential channel continues to extend with its outer extent portion rectilinearly over a long service life. However, even in the case of wide circumferential channels between the two rubber block rows, only a short circumferential channel with a small number of effective grip edges remains in the channel base. Thus, with advancing service life, even in the case of a wide circumferential channel, the admission capacity for water becomes greatly restricted. As a result, the wet grip characteristics are greatly adversely affected, without this being counteracted by effective grip edges. In the case of circumferential channels which are not of particularly wide form, the water admission capacity of a channel that remains between the rows, and the formation of remaining grip edges, is further additionally impeded, and the wet grip suitability is thus further greatly reduced. Furthermore, such an embodiment is also difficult to produce in the case of very narrow circumferential channels. Thus, such an embodiment of circumferential channels can be expediently implemented only in the case of channels with a very wide channel base.

If such a circumferential channel with flanks that are normally inclined in cross section is of V-shaped form, the circumferential channel is considerably widened yet further in the region of the radially outer surface. An excessively large width in the radially outer surface however additionally impairs the service life of the tire and adversely affects the rolling resistance. If, by contrast to the conventional V shape, the circumferential channels are formed with very steep, scarcely inclined flanks, this additional effect can duly be prevented, but such steep flanks make it easier for ingressing stones to become stuck in the circumferential channel, such that the stones can slowly penetrate into the channel base despite the rows with rubber blocks.

From DE 10 2007 016 930 A1, it is known for circumferential channels to be formed with bodies of the pyramid-shaped form, which bodies extend over a large radial extent region of the channel and are formed in alternating fashion in one or the other flank. These embodiments permit good expulsion of stones and an undulating form of the effective circumferential channel over the major part of its radial extent, and thus over the major part of its service life. In this way, it is also possible for a long effective circumferential channel for the admission and expulsion of the water to be provided with advancing service life. The undulating form is thus expedient for the expulsion of the water. The embodiment furthermore also permits good protection against ingress, and simple expulsion of ingressed stones. The undulating form of the circumferential channel along the entire depth extent of the circumferential channel can however also promote irregular wear effects in the case of tires planned for long-distance use. In the case of narrow circumferential channels, such a structure with twists of the circumferential channel formed over the entire depth of the circumferential channel is furthermore difficult to produce.

### SUMMARY OF THE INVENTION

It is an object of the invention to make it possible to realize such pneumatic vehicle tires, in particular utility vehicle tires, which both permit good protection of the channel base against ingress of stones with good wet grip characteristics over the service life and can be used in an effective manner and produced easily even in the case of narrow circumferential channels.

The object can, for example, be achieved through the formation of a pneumatic vehicle tire—in particular utility vehicle tire—having a tread profile with profile bands which are separated from one another by circumferential channels, wherein the circumferential channels are each delimited inward in a radial direction R by a channel base and to both sides of the channel base by a channel wall, wherein the two profile bands separated by the circumferential channel are delimited outward in the radial direction R by a radially outer surface, which forms the road contact surface, and in an axial direction A toward the circumferential channel in each case by a flank, which extends in the radial direction R from the channel base to the radially outer surface and which forms a channel wall of the circumferential channel, wherein, in the channel base of at least one circumferential channel, there are formed first rubber blocks arranged one behind the other in the circumferential direction U and second rubber blocks arranged one behind the other in the circumferential direction U, wherein the first rubber blocks are attached in the flank of the first profile block band and the second rubber blocks are attached in the flank of the second profile block band, in which the first and second rubber blocks are formed with a height h, measured outward in the radial direction R from the channel base, of (⅛)P_{T}≤h≤(⅓)P_{T}, where P_{T} is the profile depth measured in the circumferential channel, in which the first and second rubber blocks are arranged one behind the other in an alternating sequence in the circumferential direction U, wherein a first rubber block extends in each case in the axial direction A as far as a position in the axial extent region of two second rubber blocks arranged one behind the other and ends with a spacing to the flank of the second profile band, and wherein a second rubber block extends in each case in the axial direction A as far as a position in the axial extent region of two first rubber blocks arranged one behind the other and ends with a spacing to the flank of the first profile band.

Via such an embodiment, good protection against ingress of stones in the lower region of the circumferential channel is made possible with the aid of the rubber blocks, wherein the radially outer extent region of the circumferential channel radially outside the rubber blocks can still be optimized for good wet characteristics, good irregular wear characteristics, and long service life. In the radially inner portion of extent in the region of the channel base, the overlap, realized in the axial direction, of the positioning of the first and second rubber blocks arranged one behind the other in alternating fashion results in the formation of a long effective undulating admission channel for the admission and conduction of water, with long effective wet grip edges. The embodiment is effective even in the case of narrow circumferential channels, and is also easy to produce owing to the simple formation of the blocks, which are only close to the channel base.

An embodiment of a vehicle tire as is disclosed, wherein the first and the second flank, at least along their radial extent in their radially outer extent portion which extends between radially outer surface and the rubber blocks attached in the flank, are formed so as to extend rectilinearly in the circumferential direction. In this way, a further optimization of rolling resistance can be made possible, and the uniformity of the wear of the tire can be further improved.

An embodiment of a vehicle tire as is disclosed, wherein the rubber blocks are delimited outward in the radial direction R by a planar surface and in the direction of the circumferential channel by block flanks which extend in the radial direction R from the channel base to the planar surface. In this way, in a simple manner, additional wet grip edges are made possible on the rubber blocks between the block flanks and the planar surface, which additional wet grip edges take effect with advancing service life by means of the wear.

An embodiment of a vehicle tire is disclosed, wherein the intersection contour of the block flanks with the planar surface is formed with a polygonal profile, wherein the intersection contour has, on the side pointing in the axial direction away from that flank of the profile band to which the rubber block is attached, a rectilinear portion extending in the circumferential direction U of the tire. This permits a further optimization of the water flow through the in the circumferential channel.

An embodiment of a vehicle tire is disclosed, wherein the intersection contour has, in the circumferential direction U in front of and behind the portion extending rectilinearly in the circumferential direction U of the tire, in each case one rectilinear portion which is directed obliquely with respect to that flank of the profile band to which the rubber block is attached. This promotes good durability of the rubber blocks.

an embodiment of a vehicle tire is disclosed, wherein the intersection contour has in each case a rectilinear portion extending in an axial direction proceeding from that flank of the profile band to which the rubber block is attached. In this way, in a simple manner, particularly effective wet grip edges are made possible on the rubber blocks, which additional wet grip edges take effect with advancing service life by means of the wear.

An embodiment of a vehicle tire is disclosed, wherein the intersection contour of the block flanks with the planar surface is formed with a rounded—in particular with a circular-segment-shaped—profile. In this way, it is possible to implement a good water flow in optimized fashion, with high profile durability.

An embodiment of a vehicle tire is disclosed, wherein the planar surface has, in the section planes that have the tire axis, in each case a rectilinear intersection contour which, enclosing an angle of inclination α with the axial direction A of 0°≤α≤45°, slopes downward in the radial direction R from that flank of the profile band to which the rubber block is attached toward the flank of the other profile band. The embodiment with 0°≤α≤45° permits an edge length in the channel which is increased by means of the wear or with advancing service life of the tire, whereby the wet grip characteristics of the tire are improved with advancing wear over the service life. Here, the increase of the edge length and thus of the wet grip characteristics can be individually set in an effective manner through selection of the angle in accordance with the requirements of the tire. This permits additional degrees of freedom in the tire construction. The embodiment with α=00 permits a particular optimization of the rolling resistance.

An embodiment of a vehicle tire is disclosed, wherein the rubber blocks are of spherical-segment-shaped form. This permits a further optimization of the stone expulsion characteristics, because, owing to the form of the rubber blocks, no parallel planar surfaces are formed in the channel base.

Advantageous for the optimization of the rolling resistance is an embodiment of a vehicle tire, wherein at least one—in particular both—of the profile bands that delimit the circumferential channel is a circumferential rib.

Advantageous for the optimization of the traction characteristics is an embodiment of a vehicle tire, wherein at least one—in particular both—of the profile bands that delimit the circumferential channel is a profile block row.

### BRIEF DESCRIPTION OF THE DRAWINGS

The invention will now be described with reference to the drawings wherein:

FIG. 1 shows a circumferential section of a pneumatic utility vehicle tire in plan view,

FIG. 2 shows a circumferential channel of the pneumatic utility vehicle tire of FIG. 1 in an enlarged illustration in plan view,

FIG. 3 shows the circumferential channel of FIG. 2 in a cross-sectional illustration as per section III-III of FIG. 2,

FIG. 4 shows the circumferential channel of FIG. 2 in sectional illustration as per section IV-IV of FIG. 2,

FIG. 5 shows the circumferential channel of FIG. 2 in an alternative embodiment,

FIG. 6 shows the circumferential channel of FIG. 5 in a cross-sectional illustration as per section VI-IV of FIG. 5,

FIG. 7 shows the circumferential channel of FIG. 5 in sectional illustration as per section VII-VII,

FIG. 8 shows the circumferential channel of FIG. 1 in a further alternative embodiment,

FIG. 9 shows the circumferential channel of FIG. 8 in sectional illustration as per section IX-IX of FIG. 8,

FIG. 10 shows the circumferential channel of FIG. 8 in sectional illustration as per section X-X of FIG. 8,

FIG. 11 shows the circumferential channel of FIG. 1 in a further alternative embodiment,

FIG. 12 shows the circumferential channel of FIG. 11 in sectional illustration as per section XII-XXII of FIG. 11,

FIG. 13 shows the circumferential channel of FIG. 11 in sectional illustration as per section XIII-XIII of FIG. 11,

FIG. 14 shows a circumferential section of a pneumatic utility vehicle tire in an alternative embodiment with profile block rows,

FIG. 15 shows a circumferential channel, formed between two profile block rows, of the tread profile of FIG. 14 in an enlarged illustration in plan view,

FIG. 16 shows the circumferential channel of FIG. 15 in sectional illustration as per section XVI-XVI of FIG. 15,

FIG. 17 shows the circumferential channel of FIG. 15 in sectional illustration as per section XVII-XVII of FIG. 15,

FIG. 18 shows the circumferential channel of FIG. 15 in an alternative embodiment,

FIG. 19 shows the circumferential channel of FIG. 18 in sectional illustration as per section XIX-XIX of FIG. 18, and

FIG. 20 shows the circumferential channel of FIG. 18 in sectional illustration as per section XX-XX of FIG. 18.

### DESCRIPTION OF THE PREFERRED EMBODIMENTS OF THE INVENTION

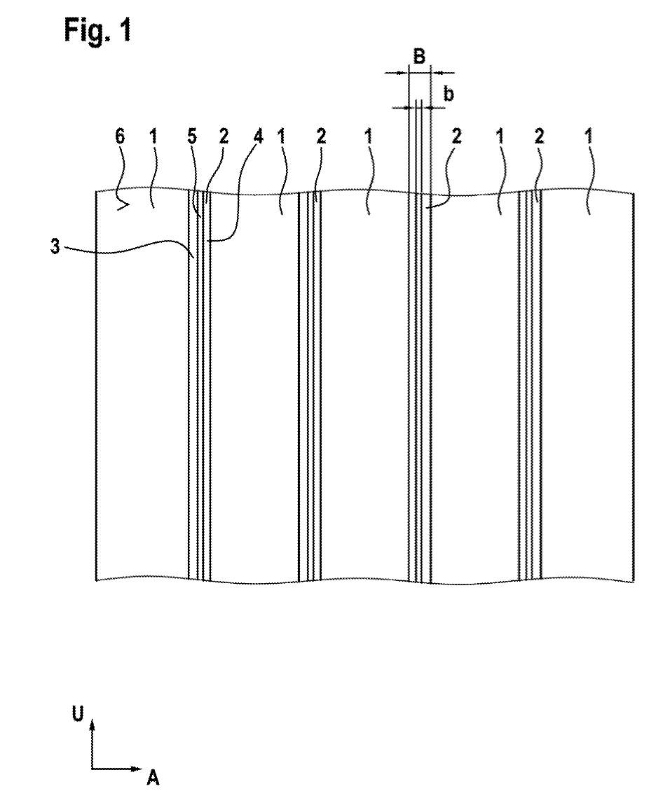

FIGS. 1 to 4 show a tread profile of a pneumatic utility vehicle tire with multiple circumferential ribs 1 which are arranged adjacent to one another in an axial direction A of the pneumatic vehicle tire and which extend over the circumference of the pneumatic vehicle tire in a circumferential direction U. Here, in each case two circumferential ribs 1 arranged adjacent to one another in the axial direction A are separated from one another in the axial direction A by a circumferential channel 2. The circumferential channels 2 extend in a known manner in the circumferential direction U of the pneumatic vehicle tire over the entire circumference of the pneumatic vehicle tire.

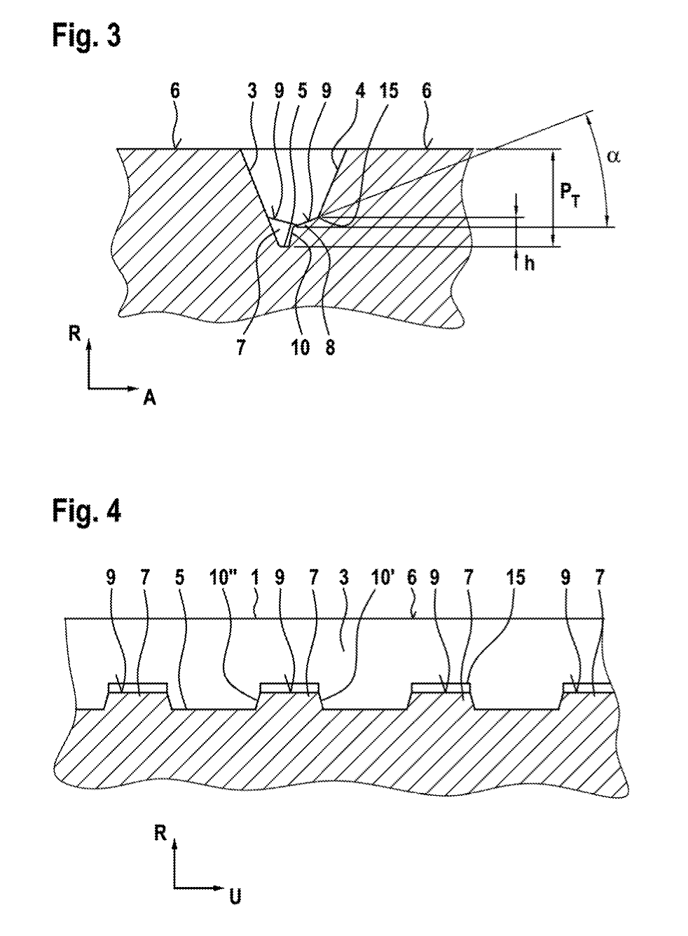

As illustrated in FIGS. 3 and 4, the circumferential ribs 1 are delimited outward in the radial direction R of the pneumatic vehicle tire by a radially outer surface 6, which forms the ground contact surface. The circumferential channels 2 are delimited inward in the radial direction R of the pneumatic vehicle tire by a channel base 2 which extends over the entire circumference of the pneumatic vehicle tire.

The circumferential ribs 1 are delimited in the axial direction A of the pneumatic vehicle tire in each case by a flank 3 or 4 of the circumferential rib 1, which forms in each case one channel wall of the adjoining circumferential channel 2. As can be seen in FIGS. 1 to 3, here, a circumferential channel 2 is delimited in the axial direction A in each case to one side by one flank 3 of an circumferential rib 1 that delimits the circumferential channel 2 and to the other side by one flank 4 of the other circumferential rib 1 that delimits the circumferential channel 2. Here, the flank 3 is formed on one axial side adjacent to the channel base 5 of the circumferential channel 2, and the flank 4 is formed on the other side adjacent to the channel base 5. Here, the flank 3 forms one channel wall, and the flank 4 forms the other channel wall of the circumferential channel 2. Here, the flanks 3 and 4 extend each case in the radial direction R radially outward from the channel base 2 to the radially outer surface 6 of the respectively adjoining circumferential rib 1.

Here, the circumferential channel 2 is formed with a profile depth P_{T} measured radial direction R of the pneumatic vehicle tire between the radially outer surface 6 of the adjoining circumferential ribs 1 and the lowest point of the channel base 2. Here, the profile depth P_{T} is configured such that 6 mm≤P_{T}≤32 mm, for example such that P_{T}=15 mm.

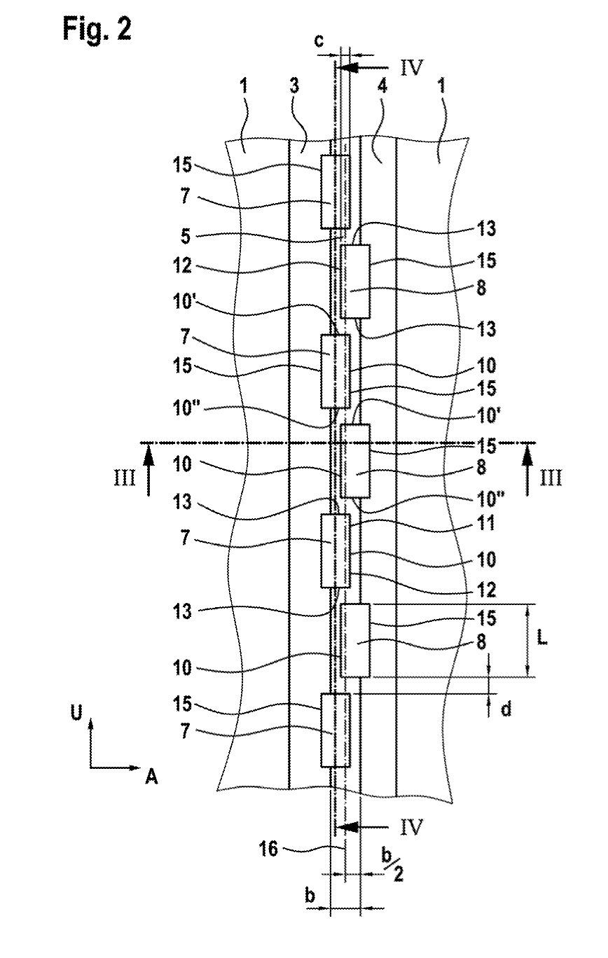

As illustrated in FIGS. 2 to 4, rubber blocks 7 are formed in the channel base 5 of the circumferential channel 2 so as to be arranged in a manner distributed one behind the other in the circumferential direction U of the pneumatic vehicle tire, which rubber blocks extend in the axial direction A from the flank 3 in the direction of the flank 4 and end with an axial spacing to the flank 4.

The rubber blocks 7 extend in the circumferential direction U of the pneumatic vehicle tire in each case over an extent length L. Likewise, rubber blocks 8 are formed in the channel base 5 of the circumferential channel 2 so as to be arranged in a manner distributed one behind the other in the circumferential direction U of the pneumatic vehicle tire, which rubber blocks extend in the axial direction A from the flank 4 in the direction of the flank 3 and end with an axial spacing to the flank 3. The rubber blocks 8 extend in the circumferential direction U of the pneumatic vehicle tire in each case over an extent length L.

Here, the rubber blocks 3 and 4 are positioned along the extent of the circumferential channel 2 in an alternating arrangement, such that each rubber block 7 is followed by a rubber block 8, and each rubber block 8 is followed by a rubber block 7.

For a simpler, clearer illustration, the rubber blocks 7 and 8 are not shown in FIG. 1.

As can be seen in FIGS. 1 and 2, the circumferential channel 2 is formed, in each case in the region of the radially outer surface 6, with a width B measured in the axial direction A and, in the channel base, with a width b, wherein B>b.

The rubber blocks 7 are delimited outward in the radial direction R of the pneumatic vehicle tire by a planar surface 9, toward the flank 4 by a rubber block flank 10, and in front of and behind the flank 10 in the circumferential direction U of the pneumatic vehicle tire in each case by a flank 10′ and a flank 10″ respectively. The flanks 10, 10′ and 10″ extend in this case in the radial direction R of the pneumatic vehicle tire from the channel base 5 to the surface 9 of the rubber block 7, and intersect the surface at an intersection contour line 11. The surface 9 of the rubber block 7 intersects the flank 3 at an intersection edge 15.

Analogously, the rubber blocks 8 are delimited outward in the radial direction R of the pneumatic vehicle tire by a planar surface 9, in the axial direction A of the pneumatic vehicle tire toward the flank 3 by a block flank 10, and in front of and behind the flank 10 in the circumferential direction in each case by a flank 10′ and 10″ respectively. The flanks 10, 10′ and 10″ extend in this case in the radial direction R of the pneumatic vehicle tire from the channel base 5 to the surface 9 of the rubber block 8, and intersect the surface at an intersection contour line 11. The surface 9 of the rubber block 8 forms, with the flank 4, an intersection edge 15.

The intersection contour line 11 of the blocks 7 is formed, in its extent portion pointing toward the flank 4, with a central portion 12 extending rectilinearly in the circumferential direction U, and in front of and behind the portion 12 in the circumferential direction, in each case with an extent portion 13 oriented rectilinearly in the axial direction A. The extent portion 13 intersects the extent portion 12 and the flank 3 at the intersection edge 15.

Analogously, the intersection contour line 11 of the blocks 8 is formed, in its extent portion directed toward the flank 3, with a central extent portion 12 extending rectilinearly in the circumferential direction U, and in front of and behind the portion 12 in the circumferential direction, in each case with an extent portion 13 oriented rectilinearly in the axial direction A. Here, the extent portion 13 intersects in each case the central extent portion 12 and the flank 4 at the intersection edge 15.

As illustrated in FIG. 2, the rubber blocks 7 and 8 are formed with a maximum extent length L in the circumferential direction U in the region of their surface 9. In the circumferential direction U of the pneumatic vehicle tire, in each case between one rubber block 8 and an adjacent rubber block 7, there is formed a spacing d measured in the circumferential direction U, where (b/2)<d<10b. The extent length L of the blocks is configured such that b<L<(10 b). As can be seen in FIG. 2, the rubber blocks 7 extend with their surface 9 proceeding from the flank 3 in the axial direction A in the direction of the flank 4 beyond the axial position of the width center of the circumferential channel 2 in the channel base 5, with a spacing (b/2) to the flank 3. Likewise, the rubber blocks 8 extend with their surface 9 proceeding from the flank 4 in the axial direction A in the direction of the flank 3 beyond the axial position of the width center of the circumferential channel 2 in the channel base 5, with a spacing (b/2) to the flank 4.

Here, the rubber blocks 7 extend with their surfaces 9 so as to axially overlap the surface 9 of the rubber blocks 8, with an overlap length c measured in the axial direction of 0 mm<c<(b/2).

As can be seen in FIGS. 3 and 4, the rubber blocks 7 and 8 extend in each case proceeding from the channel base 9 in the radial direction R as far as a height h, where (⅛)P_{T}<h<(⅓)P_{T}—for example as far as a height h=(¼)P_{T}—and end there. Here, the intersection edge 15 of the surface 9 is positioned in each case at the height h.

Here, as described, FIGS. 2 to 4 show a profile of the intersection contour line 11 of polygonal form. In the exemplary embodiment illustrated, the intersection contour line 11 forms a profile with two bend points or corners.

As illustrated in FIGS. 2 and 4, the surface 9 of the rubber blocks 7 and 8 is, proceeding from the intersection edge 15, formed so as to be inclined in the axial direction A toward the block flank 10 so as to enclose an angle of inclination α, wherein, proceeding from the intersection edge 15 toward the flank 15, the surface 9 the surface 9 slopes downward in the section planes that includes the tire axis.

Here, the angle of inclination α is configured such that 0°≤α≤45° For example, the angle of inclination α is configured such that α=5.

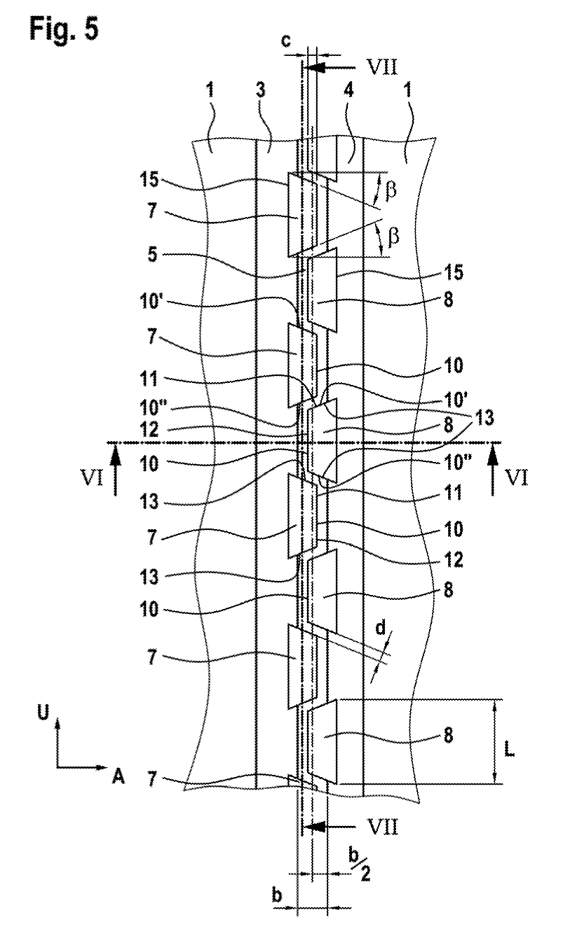

FIGS. 5 to 7 show a further alternative exemplary embodiment of the circumferential channel 2 illustrated in FIGS. 2 to 4. In this exemplary embodiment, in the case of the rubber blocks 7 and in the case of the rubber blocks 8, the portions 13 of the intersection contour lines 11 are in each case oriented so as to enclose an angle of inclination 13 with the axial direction A of the pneumatic vehicle tire, wherein the inclination orientation proceeding from the intersection edge 15 in each case along the axial extent of the two portions 13 of a surface 9 toward the central portion 12 is selected in an opposing manner. The two portions 13 that delimit a surface 9 thus converge on one another in v-shaped fashion proceeding from the intersection edge 15 toward the central section and thus in the direction of the opposite rib flank. As can be seen in FIG. 5, the extent length L of the respective rubber block 7 or 8 in the surface 9 is formed at the intersection edge 15.

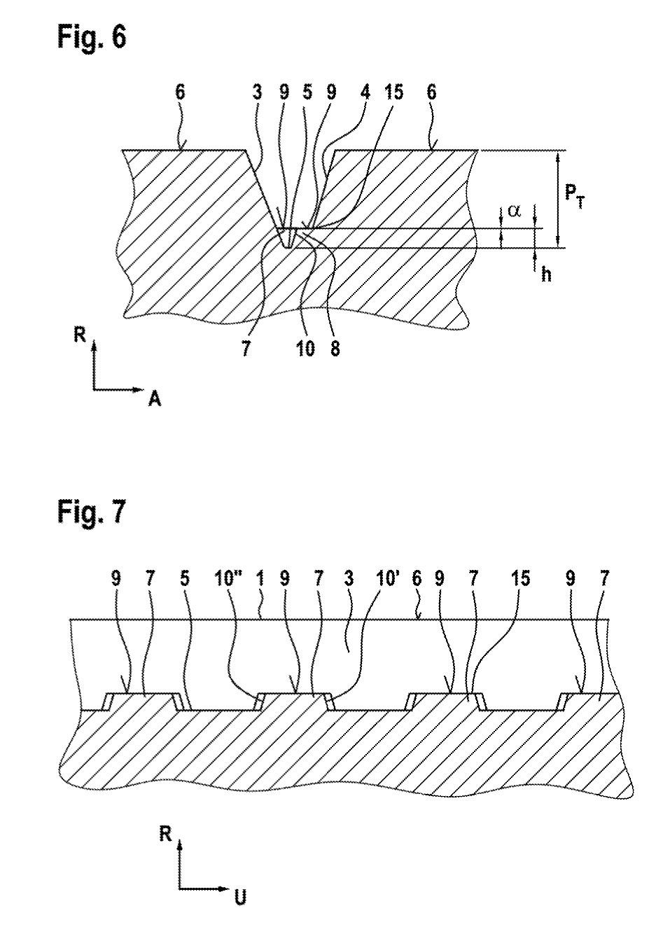

FIG. 6 illustrates a further exemplary embodiment of the surface 9 that delimits the rubber blocks 7 and 8, taking the example of a rubber block 8 in which the angle of inclination α is selected to be α=0.

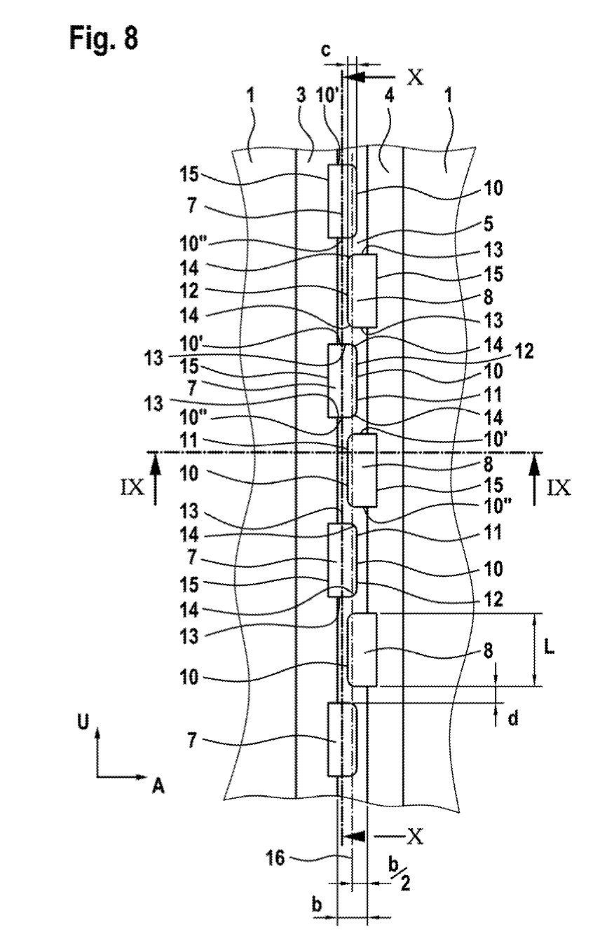

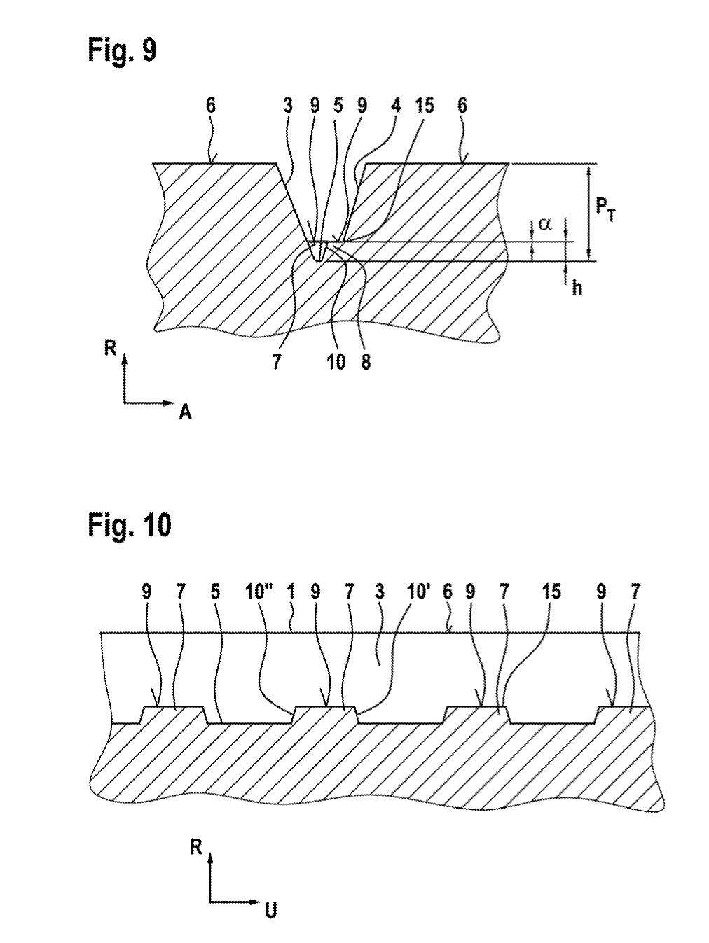

FIGS. 8 to 10 illustrate a further exemplary embodiment of a circumferential channel 2 with rubber blocks 7 and 8, which are configured as in the exemplary embodiments of FIGS. 2 to 4. As can be seen in FIG. 8, in each case one transition portion 14 rounded in circular-segment-shaped fashion is formed here between the portion 12 extending rectilinearly in the circumferential direction U and the portions 13 extending rectilinearly in front of and behind the portion 12 in the circumferential direction U.

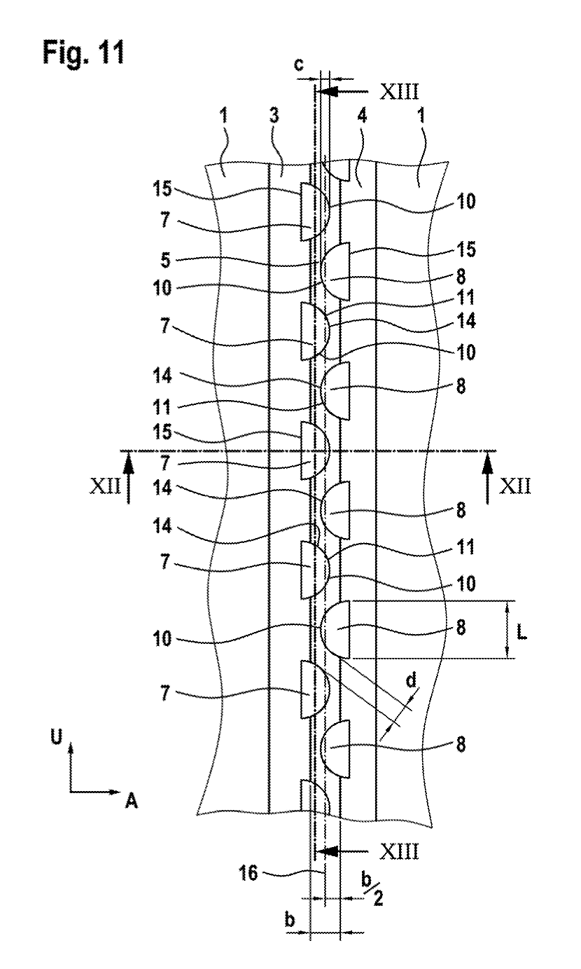

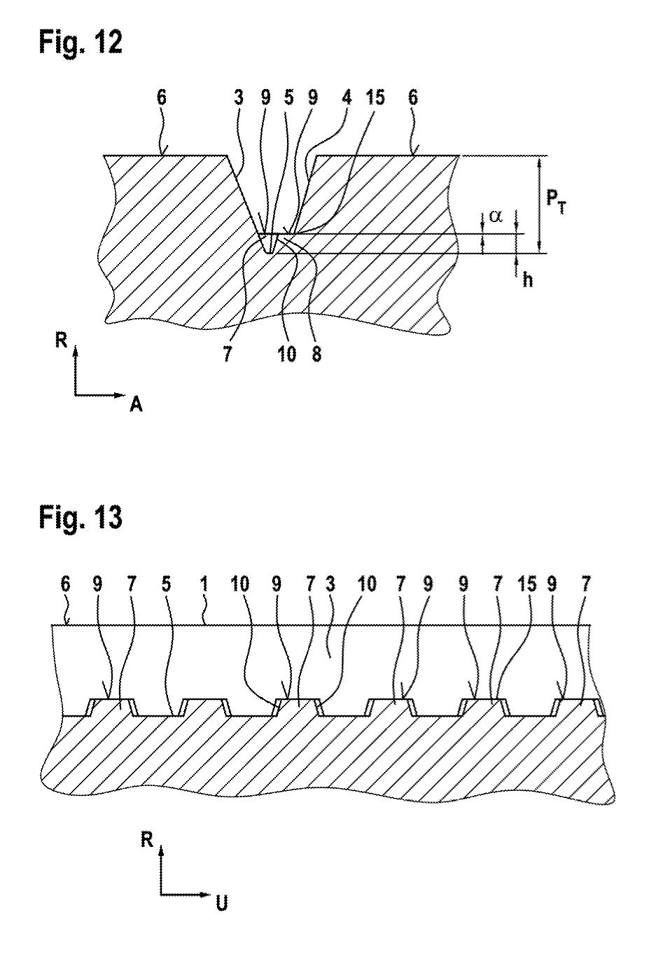

FIGS. 11 to 13 show a further exemplary embodiment of a circumferential channel 2 formed with rubber blocks 7 and 8, in the case of which the circumferential channel 2 is configured analogously to the embodiment of the circumferential channel 2 of FIGS. 2 to 4, wherein the intersection contour line 11 however forms a circular-segment-shaped contour line. In the exemplary embodiment illustrated, the circular-segment-shaped contour line 11 forms a semicircle about a central point which lies on the intersection edge 15 of the associated surface 9. In this embodiment, the respective rubber block 7 or 8 is also limited only by a cylinder-segment-shaped or frustum-segment-shaped flank 10.

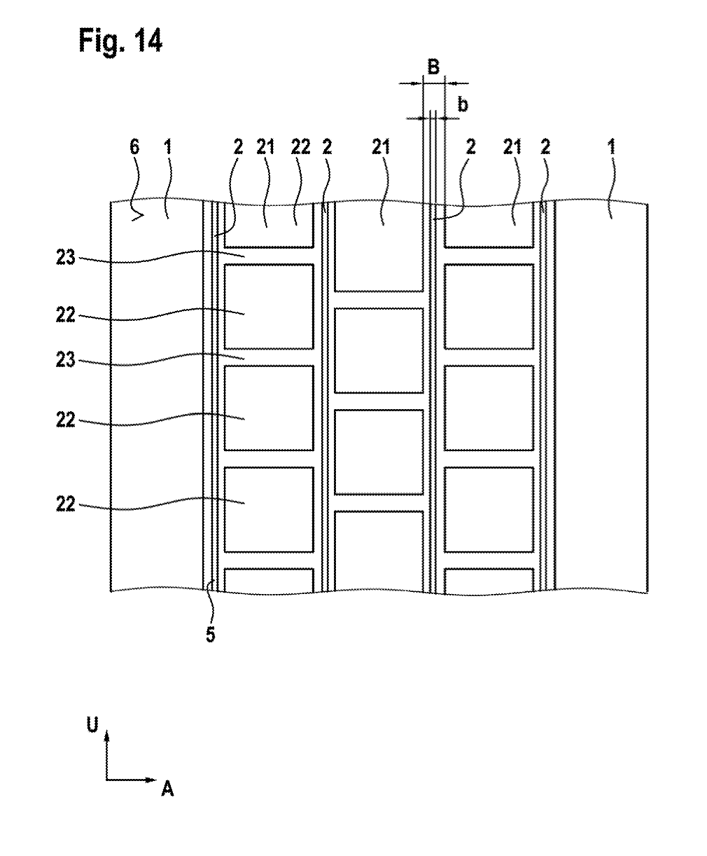

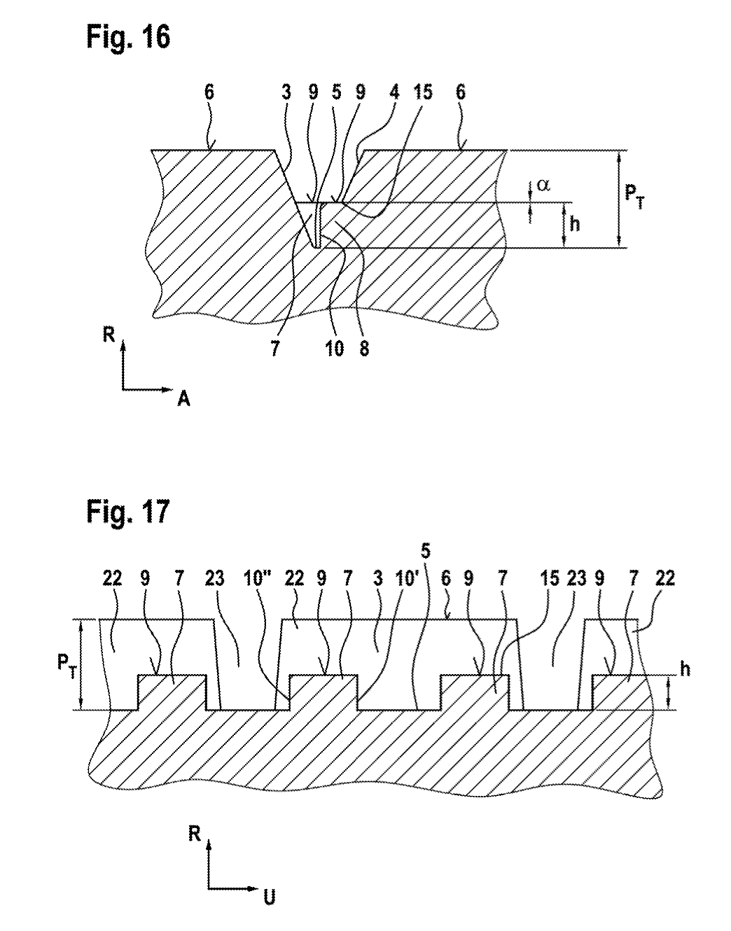

FIGS. 14 to 17 show an exemplary embodiment of a utility vehicle pneumatic tire analogous to the embodiment of FIGS. 1 to 4, in which, however, as can be seen in FIG. 14, both circumferential ribs 1 and profile block rows 21 of known type are formed. As can be seen in FIG. 14, in each case one circumferential rib 1 of known type is formed here in the two tire shoulders of the tread profile. Multiple profile block rows 21 arranged axially adjacent to one another are formed between these two circumferential ribs 1. Mutually adjacently arranged profile block rows 21 are, like the circumferential rib 1, separated from the to adjacent profile block row 21 in each case by a circumferential channel 2. The circumferential channel 2 is configured as described in conjunction with FIG. 1. The profile block row 21 extends, in a known manner, over the entire circumference of the pneumatic vehicle tire, and is formed from profile block elements 22 which are arranged one behind the other in the circumferential direction U and which are separated from one another in each case by transverse channels 23. The profile block elements 22 are, in a known manner, delimited outward in the radial direction R by a radially outer surface 6 which forms the road contact surface.

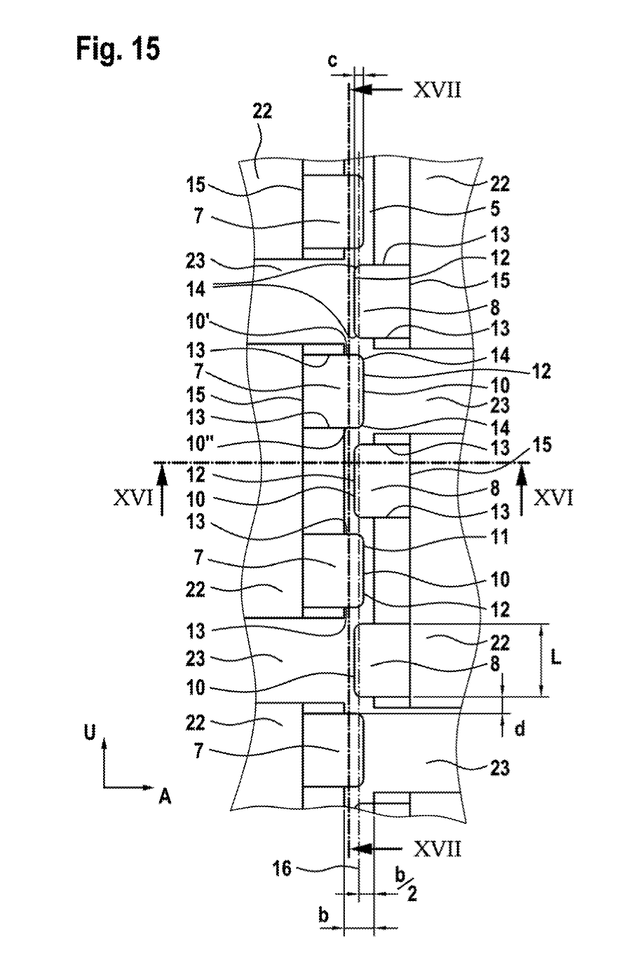

As illustrated in FIGS. 15 to 17, it is also the case in this embodiment that rubber blocks 7 and 8—as illustrated and described in conjunction with FIGS. 1 to 4—are formed in the circumferential channels 2 formed between two adjacent profile block rows 21 and in the flanks 3 and 4 which delimit the circumferential channel 2 and which form the respective channel wall. As can be seen in FIG. 15, the rubber blocks 7 are in each case attached in the flank 3 formed by the profile block elements 22 of one profile block row 21 that delimits the circumferential channel 2, and the rubber blocks 8 are attached in the flank 4 formed by the profile block elements 22 of the other profile block row 21 that delimits the circumferential channel 2.

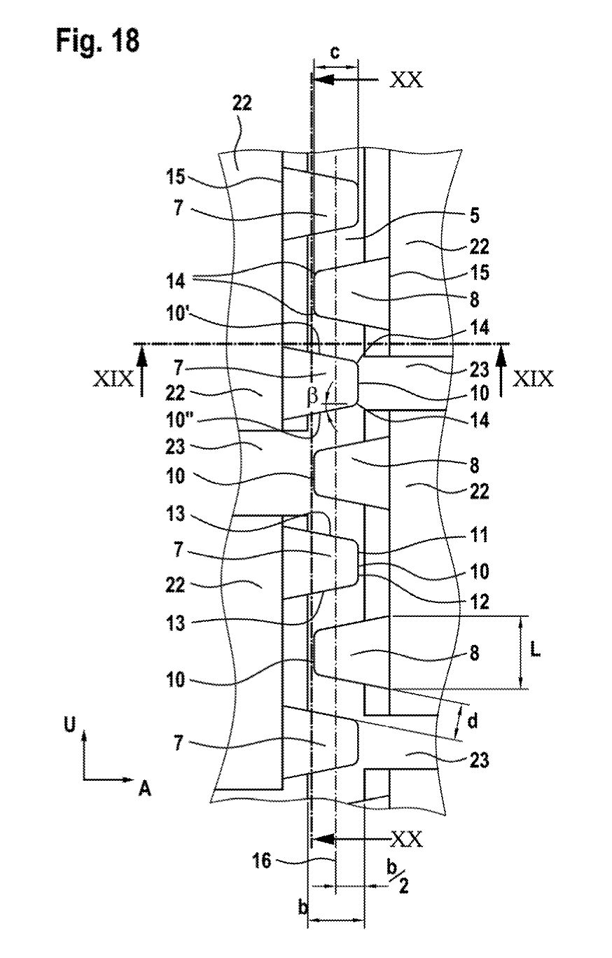

FIGS. 18 to 20 show an alternative embodiment of the circumferential channel 2 illustrated in FIGS. 15 to 17, in the case of which the surfaces 9 and the portions 12 and 13 are configured analogously to the embodiment of FIGS. 5 to 7.

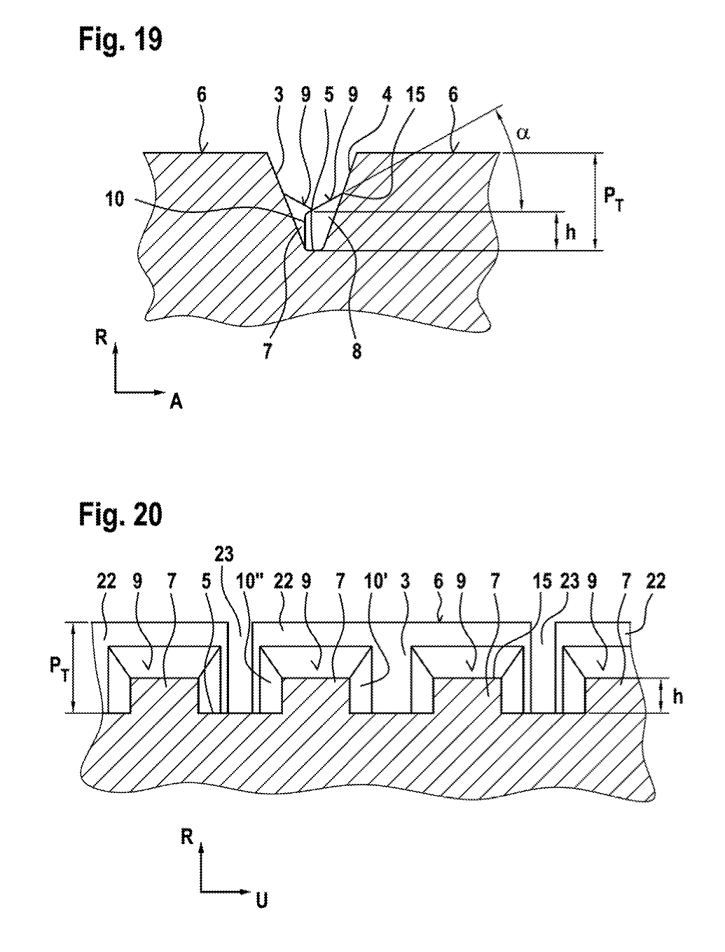

As illustrated by way of example in FIGS. 18 to 20, the surfaces 9 are also, in embodiments, formed between profile block rows 21 so as to enclose an angle of inclination α—as can be seen in FIG. 19—which is configured such that 0°≤α≤45° Here, FIG. 19 illustrates, by way of example, an embodiment with α=5°, and FIG. 17 illustrates an embodiment with α=00°.

The embodiment of the rubber blocks 7 and 8 has duly been illustrated and described in FIGS. 14 to 20 only on the basis of a small number of exemplary embodiments, but in further alternative embodiments, the other exemplary embodiments illustrated and described in FIGS. 1 to 13 are also formed in circumferential channels 2 between profile block rows 21.

Likewise, all of the abovementioned embodiments of the circumferential channel 2 with rubber blocks 7 and 8 are also formed analogously in the circumferential channels 2 that are formed between a circumferential rib 1 and the adjacent profile block row 21.

The rubber blocks 7 and 8 are, in a further embodiment that is not illustrated, of spherical-segment-shaped form, wherein the spherical segments constitute segments of a sphere which is intersected by the channel base 2 and by the respectively associated flank 3 or 4, and which is then not contacted by the other, opposite flank 4 or 3 respectively.

It is understood that the foregoing description is that of the preferred embodiments of the invention and that various changes and modifications may be made thereto without departing from the spirit and scope of the invention as defined in the appended claims.

### LIST OF REFERENCE NUMERALS

### Part of the Description

1 Circumferential rib
2 Circumferential channel
3 Flank
4 Flank
5 Channel base
6 Radially outer surface
7 Rubber block
8 Rubber block
9 Surface
10 Block flank
11 Intersection contour line
12 Portion
13 Portion
14 Portion
15 Intersection edge
21 Profile block row
22 Profile block element
23 Transverse channel

1-11. (canceled)

12. A pneumatic vehicle tire comprising:
a tread profile with a first profile band and a second profile band;
said first profile band and said second profile band being separated from one another by a circumferential channel;
said circumferential channel being delimited inwardly in a radial direction R by a channel base and being further delimited by a first channel wall on a first side of said channel base and a second channel wall on a second side of said channel base;
said first profile band being delimited outward in the radial direction R by a first radially outer surface;
said second profile band being delimited outward in the radial direction R by a second radially outer surface;
said first and second radially outer surfaces forming road contact surfaces;
said first profile band being delimited in an axial direction A toward said circumferential channel by a first flank;
said second profile band being delimited in the axial direction A toward said circumferential channel by a second flank;
said first flank extending in the radial direction R from said channel base to said first radially outer surface and forming said first channel wall;
said second flank extending in the radial direction R from said channel base to said second radially outer surface and forming said second channel wall;
a plurality of first rubber blocks formed in said circumferential channel base and arranged one behind the other in the circumferential direction U;
a plurality of second rubber blocks formed in said circumferential channel base and arranged one behind the other in the circumferential direction U;
said first rubber blocks being attached in said first flank of the first profile band;
said second rubber blocks being attached in said second flank of the second profile band;
said tread profile having a profile depth PT measured in said circumferential channel;
said first rubber blocks and said second rubber blocks being formed with a height h, measured outward in the radial direction R from said channel base, wherein said height h is (⅛)PT≤h≤(⅓)PT;
said first rubber blocks and said second rubber blocks being arranged one behind the other in an alternating sequence in the circumferential direction U;
wherein each of said first rubber blocks extends in the axial direction A as far as a position in an axial extent region of two of said second rubber blocks arranged one behind the other and ends with a spacing to said second flank of said second profile band; and,
wherein each of said second rubber blocks extends in each case in the axial direction A as far as a position in an axial extent region of two of said first rubber blocks arranged one behind the other and ends with a spacing to said first flank of said first profile band.

13. The pneumatic vehicle tire of claim 12, wherein:
said first flank has a first radially outer extent portion extending between said first radially outer surface and said first rubber blocks attached to said first flank;
said second flank has a second radially outer extent portion extending between said second radially outer surface and said second rubber blocks attached to said second flank; and,
said first flank and said second flank, at least along a radial extent in corresponding ones of said first radially outer extent portion and said second radially outer extent portion, are formed so as to extend rectilinearly in the circumferential direction.

14. The pneumatic vehicle tire of claim 12, wherein:
said first rubber blocks are delimited outward in the radial direction R by a first planar surface and in the direction of the circumferential channel by first block flanks which extend in the radial direction R from said channel base to said first planar surface; and,
said second rubber blocks are delimited outward in the radial direction R by a second planar surface and in the direction of the circumferential channel by second block flanks which extend in the radial direction R from said channel base to said first planar surface.

15. The pneumatic vehicle tire of claim 14, wherein:
said first block flanks and said first planar surface define a first intersection contour;
said second block flanks and said second planar surface define a second intersection contour;
said first intersection contour and said second intersection contour are each formed with a polygonal profile;
said first intersection contour has, on a side directed in the axial direction A away from said first flank of said first profile band, a first rectilinear portion extending in the circumferential direction U of the tire; and,
said second intersection contour has, on a side directed in the axial direction A away from said second flank of said second profile band, a second rectilinear portion extending in the circumferential direction U of the tire.

16. The pneumatic vehicle tire of claim 15, wherein:
said first intersection contour has, in the circumferential direction U in front of and behind said first rectilinear portion extending rectilinearly in the circumferential direction U of the tire, a further first rectilinear portion which is directed obliquely with respect to said first flank; and,
said second intersection contour has, in the circumferential direction U in front of and behind said second rectilinear portion extending rectilinearly in the circumferential direction U of the tire, a further second rectilinear portion which is directed obliquely with respect to said first flank.

17. The pneumatic vehicle tire of claim 15, wherein:
said first intersection contour has a further first rectilinear portion extending in an axial direction proceeding said first flank; and,
said second intersection contour has a further second rectilinear portion extending in an axial direction proceeding from said second flank.

18. The pneumatic vehicle tire of claim 14, wherein:
said first block flanks and said first planar surface define a first intersection contour formed with a rounded profile; and,
said second block flanks and said second planar surface define a second intersection contour formed with a rounded profile.

19. The pneumatic vehicle tire of claim 14, wherein:
said first block flanks and said first planar surface define a first intersection contour formed with a circular-segment-shaped profile; and,
said second block flanks and said second planar surface define a second intersection contour formed with a circular-segment-shaped profile.

20. The pneumatic vehicle tire of claim 14, wherein:
the pneumatic vehicle tire defines a tire axis;
said first planar surface has, in section planes that include the tire axis, a rectilinear intersection contour which, enclosing an angle of inclination α with the axial direction A of 0°≤α≤45°, slopes downward in the radial direction R from said first flank toward said second flank; and,
said second planar surface has, in section planes that include the tire axis, a rectilinear intersection contour which, enclosing an angle of inclination α with the axial direction A of 0°≤α≤45°, slopes downward in the radial direction R from said second flank toward said first flank.

21. The pneumatic vehicle tire of claim 12, wherein said first rubber blocks and said second rubber blocks are of spherical-segment-shaped form.

22. The pneumatic vehicle tire of claim 12, wherein at least one of said first profile band and said second profile band, which delimit said circumferential channel, is a circumferential rib.

23. The pneumatic vehicle tire of claim 12, wherein both said first profile band and said second profile band, which delimit said circumferential channel, are each a circumferential rib.

24. The pneumatic vehicle tire of claim 12, wherein at least one of said first profile band and said second profile band is a profile block row.

25. The pneumatic vehicle tire of claim 12, wherein said first profile band and said second profile band are each a profile block row.

26. The pneumatic vehicle tire of claim 12, wherein the pneumatic vehicle tire is a utility vehicle tire.
